(19) United States
(12) Patent Application Publication
(10) Pub. No.: US 2008/0155620 A1
(43) Pub. Date: Jun. 26, 2008

(54) APPARATUS, SYSTEM AND METHOD FOR CONTROLLING MULTIMEDIA SYSTEM

(75) Inventors: Shih-Cheng Chou, Taipei City (TW); Jia-Yan Yang, Taipei City (TW); Chia-ming Huang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: COMPAL ELECTRONICS, INC., Taipei City (TW)

(21) Appl. No.: 11/773,438

(22) Filed: Jul. 5, 2007

(30) Foreign Application Priority Data
Dec. 22, 2006 (TW) 95148415

(51) Int. Cl. H04N 7/173

(52) U.S. Cl. 725/100

(57) ABSTRACT

An apparatus, a system and a method for controlling multimedia system are provided. In the present method, a received wireless communication signal is translated into a control code. Next, a reference table is looked up for obtaining a control instruction corresponding to the control code. The control instruction is used for controlling a multimedia system. Therefore, a specific remote controller need not be used so that the flexibility for controlling the multimedia system may be increased. In addition, the looked-up control instruction may be remotely transmitted to a control apparatus through a network to control the multiplemedia system.

### CROSS-REFERENCE TO RELATED APPLICATION

This application claims the priority benefit of Taiwan application serial no. 95148415, filed Dec. 22, 2006. All disclosure of the Taiwan application is incorporated herein by reference.

### BACKGROUND OF THE INVENTION

1. Field of the Invention

The present invention generally relates to a control apparatus, a control system and a control method, and more particularly, to an apparatus, a system and a method for controlling multimedia system.

2. Description of Related Art

Multimedia center edition (MCE) system is a new interface provided by the Microsoft Corporation for integrating multimedia functions. The MCE system can combine the Microsoft Windows operation system with multimedia devices, such as home televisions, stereos, network and so on, such that the multimedia functions required for digital family can be obtained. The MCE system may be loaded into a home computer, such that the home computer can not only allow the user to operate some of the basic functions, such as general paper work, web browsing and so on, but also can allow the user to watch television programs, DVD movies, or listen to music and radio, or pre-recorded television programs or singing KTV at home. In addition, users also can download music and movies, or perform other services, such as online users also can download music and movies, or perform other services, such as online teaching, online games, online shopping, and so on.

The MCE system may be disposed in a general personal computer so that users can freely switch between a general Windows interface and the MCE system interface to display photographs or images stored in the hard disk of a home computer on the screen of a home television. This may thoroughly overturn the definition of a personal computer (PC), such that entertainment can be shared by family members at home in every corner.

In addition, in the MCE system, multimedia functions are integrated, and the operation interface is also simplified to control every operation with a remote controller. Through the combination between a computer and a television, when a user turns on a home television, the image displayed on the television screen is no longer just an image of a television program, but also an image of a windows operating system. Users can control the windows interface on the television screen and select multimedia functions by a remote controller that are compatible with the specifications of the MCE system.

However, the method for controlling multimedia interface with a remote controller is very convenient, but the specifications must be certificated by the MCE system, and computer end must also be equipped with USB interface receiver which should comply with the specifications of the MCE system, so as to provide the functions of receiving, playing, synchronizing, and pre-recording. Thus, the structure not only limits the types of remote controller, but also limits multimedia functions of remote controller, such that users can not control the MCE system by using other types of “wireless transmission apparatus”, and can not design control functions meeting their own needs.

### SUMMARY OF THE INVENTION

Accordingly, the present invention is directed to an apparatus for controlling multimedia system, wherein a received wireless communication signal is translated into a control code by a translating module, and in a driving module, an instruction reference table is looked up for obtaining a control instruction corresponding to the control code. Thus, the present apparatus may support wireless communication signals provided by various types of remote controllers, and not be limited to the wireless communication signal provided by an infrared remote controller.

The present invention is also directed to a system for controlling multimedia system. A wireless communication signal may be received by a first control apparatus and may be translated into a control instruction. Then, the control instruction may be transmitted to a second control apparatus in the other end through a network, so as to control the multimedia system in the other end to perform a function, such that the purpose of remote control is achieved.

The present invention is also directed to a method for controlling multimedia system. The method may control the multimedia system to perform a function by translating a wireless communication signal transmitted by a hand-held communication apparatus into a control instruction of the multimedia system. The method can translate various types of wireless communication signals, so as to increase the flexibility of the control of multimedia system.

An apparatus for controlling multimedia system is provided. The apparatus comprises a receiving unit, a translating module and a driving module. The receiving unit may be employed for receiving a wireless communication signal transmitted by a hand-held communication apparatus through a wireless transmission mode. The translating module may translate the wireless communication signal received by the receiving unit into a control code. The driving module may find a control instruction corresponding to the control code according to an instruction reference table, and the driving module may also transmit the control instruction to a multimedia system to control the multimedia system to perform a function.

In an embodiment of the present invention, the translating module mentioned above comprises a multi-mode signal processing unit and a decoding unit. Wherein, the multi-mode signal processing unit may perform a stack processing for a wireless communication signal, and package the processed wireless communication signal to a packet datum. The decoding unit may decode the packet datum to a control code.

In an embodiment of the present invention, the translating module further comprises a control unit. The control unit is suitable for sending a control signal to the multi-mode signal processing unit. And the control signal comprises a preset format assigned for the packet datum.

In an embodiment of the present invention, operations of the multi-mode signal processing unit further comprise sending the packet datum complying with the preset format to the decoding unit to perform a decoding operation.

In an embodiment of the present invention, the translating module further comprises a control unit. The control unit may judge whether the format of the packet datum comply with the preset format. If the format of the packet complies with the preset format, the packet datum is transmitted to the decoding unit to perform a decoding operation. If the format of the packet does not comply with the preset format, the packet datum is not transmitted to the decoding unit.

The present invention is also directed to a control system for controlling multimedia system. The system comprises a first control apparatus and a second control apparatus. The first control apparatus further comprises a receiving unit, a translating module, a first driving module and a first network transmission unit. The receiving unit is used for receiving a wireless communication signal transmitted by a hand-held communication apparatus through a wireless transmission mode. The translating module may translate the wireless communication signal received by the receiving unit into a control code. The first driving module may find a control instruction corresponding to the control code according to an instruction reference table. The first network transmission unit may transmit the control instruction to another end through the network. In addition, the second control apparatus comprises a second network transmission unit and a second driving module. Wherein, the second network transmission unit receives the control instruction transmitted by the first network transmission unit of the first control apparatus through the network. The second driving module can transmit the control instruction to a second multimedia system to control the second multimedia system to perform a function.

In an embodiment of the present invention, the first driving module of the first control apparatus further comprises transmitting the control instruction to a first multimedia system, so as to control the first multimedia system to perform a function.

In an embodiment of the present invention, the first control apparatus further comprises a storage unit. The storage unit is used for storing the control instruction.

In an embodiment of the present invention, the hand-held communication apparatus is, for example, a handset or a personal digital assistant, and the wireless transmitting modes comprise infrared, radio, bluetooth or wireless fidelity wireless transmission.

The present invention is also directed to a method for controlling multimedia system. The method is suitable for a first control apparatus and may be described as follows. First, a wireless communication signal provided by a hand-held communication apparatus is received through a wireless transmission mode. Next, the wireless communication signal may be translated into a control code, and an instruction reference table is looked up to find a control instruction corresponding to the control code. Next, the control instruction may be transmitted to a multimedia system, so as to control the multimedia system to perform a function.

In an embodiment of the present invention, the control instruction may be transmitted to a second control apparatus through a network, and the second control apparatus may send the control instruction to a second multimedia system to control the second multimedia system to perform a function.

In an embodiment of the present invention, an inquiry signal may be sent to the network before the control instruction is transmitted to the second apparatus through the network, and a validation signal returned by the network may be detected. And when the validation signal returned by the second control apparatus is received, the control instruction may be transmitted to the second control apparatus.

In an embodiment of the present invention, the step of translating a wireless communication signal into a control code comprises performing a stack processing for the wireless communication signal, and packaging the processed wireless communication signal to a packet datum, then, the packet datum is decoded to the control code.

In the present invention, a received wireless communication signal is translated into a control code. Next, a reference table is looked up for obtaining a control instruction corresponding to the control code. The control instruction is used for controlling a multimedia system. Therefore, the structure and the method of the present invention need not use the specific remote controller, and therefore the flexibility of controlling the multimedia system may be increased. In addition, the looked-up control instruction can be transmitted to a control apparatus in the other end through the network and used for controlling the multimedia system in the other end, such that the purpose of remote control is achieved.

These and other exemplary embodiments, features, aspects, and advantages of the present invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a system for controlling multimedia system according to an embodiment of the present invention.

FIG. 2 is a block diagram illustrating a translating module according to an embodiment of the present invention.

FIG. 3 is a flowchart illustrating a method for controlling multimedia system according to an embodiment of the present invention.

FIG. 4 is a block diagram illustrating a system for controlling multimedia system according to an embodiment of the present invention.

FIG. 5 is a flowchart illustrating a method for controlling multimedia system according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

With the development of wireless techniques, except for the conventional wireless transmission modes, such as infrared, radio and so on, nowadays, new generation wireless transmission modes have been developed, such as bluetooth and wireless fidelity (Wi-Fi) and so on. Correspondingly, the wireless transmission apparatuses that comply with the specifications of the wireless transmission have also appeared on the market. Particularly, almost everybody has a hand-held communication apparatus such as a handset, a personal digital assistant and so on. If users can transmit “a control instruction” to a television or an MCE system mentioned above by using wireless transmission functions of the “wireless transmission apparatuses”, the purpose of remote control for a television or a computer can be achieved, and users need not use a remote controller or a receiver. Based on the foregoing concept, the present invention provides an apparatus, a system and a method for controlling multimedia system. These and other exemplary embodiments, features, aspects, and advantages of the present invention will be described and become more apparent from the detailed description of exemplary embodiments when read in conjunction with accompanying drawings.

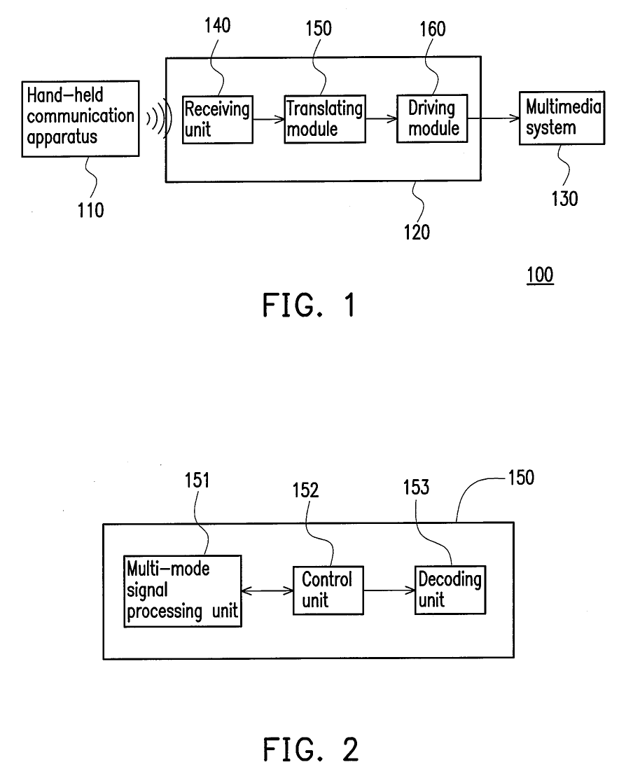

FIG. 1 is a block diagram illustrating a system for controlling multimedia system according to an embodiment of the present invention. Referring to FIG. 1, in the embodiment, the system for controlling multimedia system comprises a hand-held communication apparatus 110, a control apparatus 120 and a multimedia system 130. Wherein, the control apparatus 120 further comprises a receiving unit 140, a translating module 150 and a driving module 160. Hereinafter, detailed functions of the elements will be described.

As shown in FIG. 1, the receiving unit 140 can receive a wireless communication signal transmitted by the hand-held communication apparatus 110 through a wireless transmission mode. Wherein, the hand-held communication apparatus 110 is, for example, a handset or a personal digital assistant operated by users, and the wireless transmission mode supported by the hand-held communication apparatus 110 comprises infrared, radio, bluetooth, wireless fidelity (Wi-Fi) and so on. The scope of the present invention is not limited there-to as such.

The translating module 150 is connected to the receiving unit 140, and is used to translate a wireless communication signal received by the receiving unit 140 to a control code. The translating module further comprises a plurality of elements. FIG. 2 is a block diagram illustrating a translating module according to an embodiment of the present invention. Referring to FIG. 2, the translating module 150 comprises a multi-mode signal processing unit 151, a control unit 152 and a decoding unit 153. Wherein, the multi-mode signal processing unit 151 may perform a stack processing for the wireless communication signal, and the processed wireless communication signal may be converted to a corresponding picket datum. The control unit 152 may send a control signal to the multi-mode signal processing unit to set a preset format of the picket datum. After receiving the control signal, the multi-mode signal processing unit 151 may only transmit the picket datum that complies with the preset format to the decode unit 153. Next, the picket datum may be decoded to a control code by the decoding unit 153.

It should be noted that the control unit 152 mentioned above may judge whether the format of the picket datum complies with the preset format. If the format of the picket datum complies with the preset format, the picket datum is transmitted to the decoding unit to perform a decoding operation, and if the format of the picket datum does not comply with the preset format, the picket datum is not transmitted to the decoding unit. Thus, the wireless communication signals that do not comply with the specifications will be filtered out, so as to avoid interference by the signals.

The driving module 160 is connected to the back end of the translating module 150, and is used to receive the control code provided by the translating module 150. And a instruction reference table built in the driving module 160 is looked up to find a control instruction corresponding to the control code. Finally, the control instruction is transmitted to the multimedia system 130, so as to control the multimedia system 130 to perform a multimedia function required by the above-said hand-held communication apparatus 110.

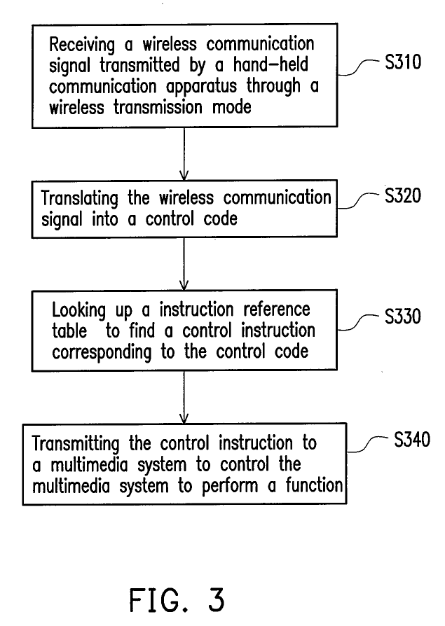

The present invention is also directed to a method for controlling multimedia system, which is described as follows. FIG. 3 is a flowchart illustrating a method for controlling multimedia system according to an embodiment of the present invention. Referring to FIG. 3, the embodiment is suitable for the above-said control apparatus 120.

In step S310, first, a wireless communication signal transmitted by a hand-held communication apparatus is received through a wireless transmission mode. Wherein, the hand-held communication apparatus and the wireless transmission mode herein are all same with those of the embodiments mentioned above, the detailed description thereof is omitted.

Next, in step S320, the wireless communication signal is decoded to a control code. In more detail, in this step, a stack processing is performed for the wireless communication signal, and the processed wireless communication signal is packaged into a packet datum, and then, the packet datum is decoded to the control code. Before the packet datum is decoded, a comparison operation may be performed to judge whether the format of the picket datum complies with a preset format by using one judging mechanism. If the format of the picket datum complies with the preset format, the picket datum is decoded, if the format of the picket datum does not comply with the preset format, the picket datum is not decoded. Thus, the wireless communication signals not complying with the specifications may be filtered out such that a multimedia system can be prevented from suffering misoperation due to incorrect control instruction.

In step S330, a preset instruction reference table is looked up to find a control instruction corresponding to the control code. The instruction reference table may be a control-code-to-control-instruction conversion table designed by the system maker according to functions of the multimedia system, or a reference table designed by users according to users' custom and demand. It is understood that the purpose of the instruction reference table is not only to collate control codes, but also to increase the flexibility of operation functions of multimedia system.

Finally, in step S340, the control instruction is transmitted to a multimedia system to control the multimedia system to perform a multimedia function. The multimedia function mentioned herein comprises operations mentioned in the above multimedia system, such as processing paper work, watching television and DVD movies, playing music and radio, or web browsing, on-line teaching, on-line games, on-line shopping, and so on. It is understood that the scope of the present invention is not limited to them.

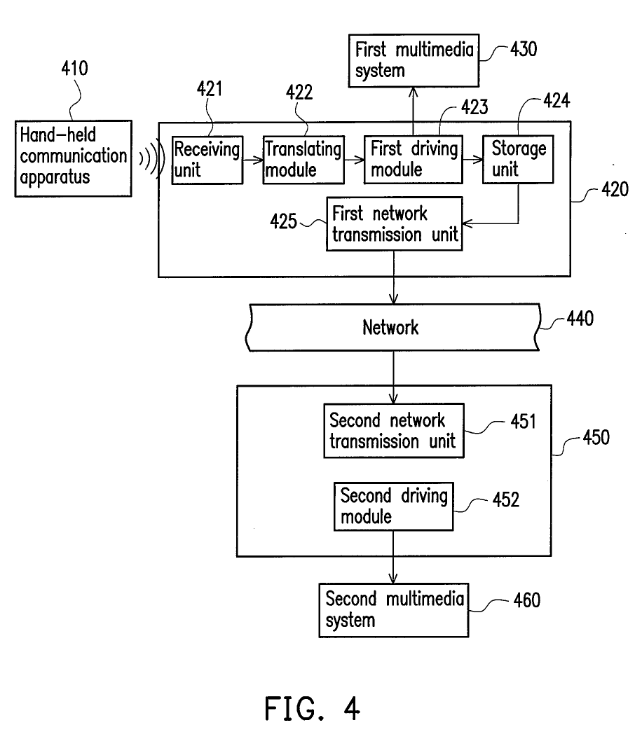

According to the present invention, users can not only perform the above operations suitable for home multimedia system, but also can remotely control a multimedia system through the network, which is described as follows. FIG. 4 is a block diagram illustrating a system for controlling multimedia system according to an embodiment of the present invention. Referring to FIG. 4, a control system 400 of the multimedia system of the embodiment is divided into a control end and a be-controlled end by a network 440. The control end comprises a hand-held communication apparatus 410, a first control apparatus 420 and a multimedia system 430, and the be-controlled end comprises a second control apparatus 450 and a multimedia system 460. Wherein, the first control apparatus 420 further comprises a receiving unit 421, a translating module 422, a driving module 423, a storage unit 424 and a first network transmission unit 425. The second control apparatus 450 comprises a second network transmission unit 451 and a second driving module 452.

The receiving unit 421, the translating module 422 and the first driving module 423 in the first control apparatus 420 are all identical or similar to the receiving unit 140, the translating module 150 and the driving module 160 mentioned above, therefore the detailed description is omitted. In the embodiment, a network transmission mechanism is added, thus through the network 440, a control instruction may be transmitted to the other end of the network, such that the purpose of the remote control of multimedia system is achieved. The functions of the other elements of the embodiment are as follows.

The storage unit 424 is used to store a control instruction looked up by the first driving module 423, and the first network transmission unit 425 may be connected to the second control apparatus 450 in the other end through the network 440, and transmit the control instruction stored in the storage unit 424 to the second control apparatus 450.

The second network transmission unit 451 of the second control apparatus 450 is used to set up network connection with the first network transmission unit 425, and receives a control instruction transmitted by the first network transmission unit 425. The second driving module 452 may transmit the control instruction received by the second network transmission unit 451 to the second multimedia system 460, so as to control the second multimedia system 460 to perform a function.

It should be noted that in the present embodiment, the control code translated by the translating module 422 is the control instruction looked up by the first driving module 423, and the data transmitted through the network 440 is also a converted control instruction. However, in another embodiment of the present, the control code from the translating module 422 may be transmitted to the second control apparatus 450 directly through the network 440, and a reference table is looked up by the second driving module 452 to find the corresponding control instruction. It is understood that the present invention is not limited to the types of data transmitted over the network 440. Only if the format of the datum is certificated by the first control apparatus 420 and the second control apparatus 450, the purpose of remote control of the present invention may also be achieved.

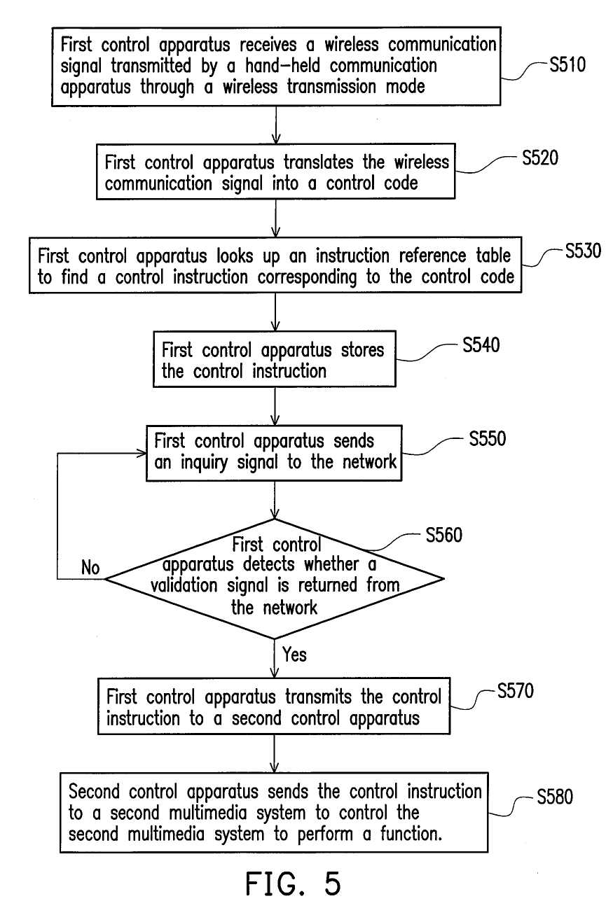

The present invention provides a method for controlling multimedia system, which is described as follows. FIG. 5 is a flowchart illustrating a method for controlling multimedia system according to an embodiment of the present invention. Referring to FIG. 5, the embodiment is suitable for the above-said system 400 for controlling multimedia system.

In step S510, a first control apparatus can receive a wireless communication signal transmitted by a hand-held communication apparatus through a wireless transmission mode. Next, in step S520, the wireless communication signal is further decoded to a control code. Then, in step S530, a preset instruction reference table is looked up to find a control instruction corresponding to the control code. The above steps are identical or similar to the steps S310 to S330 as described above, thus the detailed description thereof is omitted. In the embodiment, the multimedia system on far end will be controlled by the obtained control instruction.

In step S540, the first control apparatus stores the control instruction in a storage unit. The storage unit is, for example, a register or a memory, but not limited to them.

Next, in step S550, the first control apparatus sends an inquiry signal to the network to determine whether another apparatus shares the multimedia system with the first control apparatus. At the same time, in step S560, the method may detect whether a validation signal is returned from the network. If a second control apparatus receives the inquiry signal and wants to share the control right of a second multimedia system connected to itself, a validation signal may be returned to the first control apparatus.

In step S570, if the first control apparatus receives the returned validation apparatus; if the first control apparatus does not receive the returned validation signal, the method returns to the step S550 to continue to determine whether another apparatus wants to share the multimedia system with the first control apparatus.

Finally, in step S580, the second control apparatus sends the control instruction to the second multimedia system to control the second multimedia system to perform functions. Accordingly, users may send a control instruction to control the multimedia system in remote end by using a hand-held communication apparatus without the need of using a formal remote controller and without limiting the functions of the multimedia system.

In summary, some advantages of the present invention are described as follows:

1. A general hand-held communication apparatus with wireless transmission function may be used as a remote controller, and operations, such as signal processing, and data conversion may be performed with existing elements in a computer, such that there is no need to buy additional remote controllers and receivers.

2. A converted instruction may be transmitted through the network, so as to remotely control a multimedia system.

3. Users may design their own instruction reference table which is not limited to formal control instructions, so as to increase the flexibility of operating multimedia functions.

It will be apparent to those skilled in the art that various modifications and variations can be made to the structure of the present invention without departing from the scope or spirit of the invention. In view of the foregoing, it is intended that the present invention cover modifications and variations of this invention provided they fall present invention cover modifications and variations of this invention provided they fall within the scope of the following claims and their equivalents.

What is claimed is:

1. An apparatus for controlling multimedia system, comprising:
a receiving unit, for receiving a wireless communication signal transmitted by a hand-held communication apparatus through a wireless transmission mode;
a translating module, for translating the wireless communication signal received by the receiving unit into a control code; and
a driving module, for finding a control instruction corresponding to the control code according to an instruction reference table, and transmitting the control instruction to a multimedia system to control the multimedia system to perform a function.

2. The apparatus for controlling multimedia system according to claim 1, wherein the translating module comprises:
a multi-mode signal processing unit, for performing a stack processing for the wireless communication signal, and packaging the processed wireless communication signal into a packet datum; and
a decoding unit, for decoding the packet datum to the control code.

3. The apparatus for controlling multimedia system according to claim 2, wherein the translating module comprises a control unit for sending a control signal to the multi-mode signal processing unit, and wherein the control signal comprises a preset format assigned for the packet datum.

4. The apparatus for controlling multimedia system according to claim 3, wherein the packet datum complying with the preset format is sent to the decoding unit to perform a decoding operation.

5. The apparatus for controlling multimedia system according to claim 2, wherein the translating module comprises:
a control unit, for judging whether a format of the packet datum complies with a preset format,
wherein, if the format of the packet datum complies with the preset format, the packet datum is transmitted to the decoding unit to perform a decoding operation, and
wherein if the format of the packet does not comply with the preset format, the packet datum is not transmitted to the decoding unit.

6. The apparatus for controlling multimedia system according to claim 1, wherein the hand-held communication apparatus comprises a handset or a personal digital assistant.

7. The apparatus for controlling multimedia system according to claim 1, wherein the wireless transmission mode comprises an infrared, a radio frequency, a bluetooth or a wireless fidelity wireless transmission.

8. A system for controlling multimedia system, comprising:
a first control apparatus, comprising:
a receiving unit, for receiving a wireless communication signal transmitted by a hand-held communication apparatus through a wireless transmission mode;
a translating module, for translating the wireless communication signal received by the receiving unit into a control code;
a first driving module, for finding a control instruction corresponding to the control code according to an instruction reference table; and
a first network transmission unit, for transmitting the control instruction through a network; and
a second control apparatus, comprising:
a second network transmission unit, for receiving the control instruction through the network; and
a second driving module, for transmitting the control instruction to a second multimedia system to control the second multimedia system to perform a function.

9. The system for controlling multimedia system according to claim 8, wherein the first driving module of the first control apparatus further comprises:
transmitting the control instruction to a first multimedia system to control the first multimedia system to perform the function.

10. The system for controlling multimedia system according to claim 8, wherein the translating module comprises:
a multi-mode signal processing unit, for performing a stack processing for the wireless communication signal, and packaging the processed wireless communication signal to a packet datum; and
a decoding unit, for decoding the packet datum to the control code.

11. The system for controlling multimedia system according to claim 10, wherein the translating module comprises a control unit for sending a control signal to the multi-mode signal processing unit, and wherein the control signal comprises a preset format assigned for the packet datum.

12. The system for controlling multimedia system according to claim 11, wherein the multi-mode signal processing unit comprises sending the packet datum complying with the preset format to the decoding unit to perform a decoding operation.

13. The system for controlling multimedia system according to claim 11, wherein operations of the control unit comprises:
judging whether or not the format of the packet datum complies with a preset format,
wherein, if the format of the packet complies with the preset format, the packet datum is transmitted to the decoding unit to perform a decoding operation, and
wherein if the format of the packet does not comply with the preset format, the packet datum is not transmitted to the decoding unit.

14. The system for controlling multimedia system according to claim 8, wherein the first control apparatus comprises a storage unit configured between the first driving module and the first network transmission unit for storing a control instruction.

15. The system for controlling multimedia system according to claim 8, wherein the hand-held communication apparatus comprises a handset or a personal digital assistant.

16. The system for controlling multimedia system according to claim 8, wherein the wireless transmission mode comprises an infrared, a radio frequency, a bluetooth or a wireless fidelity wireless transmission.

17. A method for controlling multimedia system for a first control apparatus, comprising:
receiving a wireless communication signal transmitted by a hand-held communication apparatus through a wireless transmission mode;
translating the wireless communication signal into a control code;
looking up into a instruction reference table to find a control instruction corresponding to the control code; and
transmitting the control instruction to a multimedia system to control the multimedia system to perform a function.

18. The method for controlling multimedia system according to claim 17, further comprising:
sending the control instruction to a second control apparatus through a network; and
sending the control instruction from the second control apparatus to a second multimedia system to control the second multimedia system to perform a function.

19. The method for controlling multimedia system according to claim 18, further comprising a step of sending an inquiry signal to the network and detecting a validation signal returned by the network before the step of sending the control instruction to the second control apparatus through the network, wherein when receiving the validation signal returned by the second control apparatus, the control instruction is transmitted to the second control apparatus.

20. The method for controlling multimedia system according to claim 17, wherein the step of translating the wireless communication signal into the control code comprises:
performing a stack processing for the wireless communication and packaging the processed wireless communication signal into a picket datum; and
translating the picket datum into the control code.

21. The method for controlling multimedia system according to claim 20, further comprising a step of judging whether a format of the packet datum complies with a preset format before the step of translating the picket datum, wherein if the format of the packet datum complies with the preset format, the picket datum is decoded and if the format of the packet does not comply with the preset format, the packet datum is not decoded.

22. The method for controlling multimedia system according to claim 17, wherein the wireless transmission mode comprises an infrared, a radio frequency, a bluetooth or a wireless fidelity wireless transmission.
